(19) United States
(12) Patent Application Publication
(10) Pub. No.: US 2012/0211527 A1
(43) Pub. Date: Aug. 23, 2012

(54) DISPENSER

(75) Inventors: Rainer Strobel-Schmidt, Bad Woerishofen (DE); Christian Hefele, Breitenbrunn (DE); Peter Ostermeier, Diessen (DE)

(73) Assignee: Hilti Aktiengesellschaft, Schaan (LI)

(21) Appl. No.: 13/358,676

(22) Filed: Jan. 26, 2012

(30) Foreign Application Priority Data
Jan. 27, 2011 (DE) DE 102011003236.3

(51) Int. Cl. G01F 11/06; B05C 17/01

(52) U.S. Cl. 222/309; 222/326; 222/391

(57) ABSTRACT

A dispenser (10) for cartridges includes at least one piston rod (16), an advancer (20) that can be coupled incrementally to the piston rod (16) in order to move the piston rod (16) in a dispensing direction (R), and it also includes a selectively adjustable controller (22) for the variable pre-selection of the path of travel (D) of the piston rod (16) that, once it has traversed the pre-selected path of travel, uncouples the advancer (20) from the piston rod (16).

This claims the benefit of German Patent Application DE 10 2011 003 236.3, filed Jan. 27, 2011 and hereby incorporated by reference herein.

The invention relates to a dispenser for cartridges, comprising at least one piston rod and an advancing means for the piston rod.

### BACKGROUND

Such dispensers are used, for example, in the construction sector to dispense the contents of cartridges that are filled with silicon or other liquid or viscous construction materials. These cartridges normally have a cylindrical body with a dispensing opening in one of the end walls. The opposite end wall is formed by a plunger that can be moved in the cylindrical body, so that moving this end wall changes the volume of the cartridge so that the contents of the cartridge can be expelled from the dispensing opening. The dispenser allows a precise dosing as well as a precise application of the construction material in question. Normally, the dispenser has a piston that is arranged on a piston rod and that can engage with the plunger and force it against the dispensing opening in order to dispense the contents of cartridge. The piston rod is driven by means of an advancing mechanism that can be detachably clamped onto this piston rod.

Many applications require a precise dosing of the dispensed amount of the construction material. Normally, this dosing is done by means of a visual inspection of the dispensed construction material or by limiting the path of travel of the piston rod and thus limiting the volume that can be dispensed from the cartridge. From the state of the art, mechanical stops are known that are affixed onto the piston rod and that move against a stop on the housing side in order to limit the path of travel. A drawback of these stops is that they have to be readjusted or set again after each dosing procedure, as a result of which the work cannot be carried out quickly and efficiently. Moreover, the repeated setting can lead to inaccuracies, so that precise dosing of the construction material is not ensured. In the state of the art, the user had to count the number of dispensing strokes in order to roughly determine the dispensed quantity, which is imprecise since the dispensed quantity is dependent on the ambient temperature (differences in the viscosity) and on the dispensing forces. Furthermore, especially in the case of highly viscous construction materials and the high application forces thus needed, the problem arises that the user cannot immediately see that the stop has come into contact with the housing and that the operation can be terminated. Consequently, the use of high forces can cause the stop and even the entire dispenser to become deformed and damaged.

German patent application DE 42 31 418 A1 constitutes the closest state of the art.

### SUMMARY OF THE INVENTION

It is an object of the present invention to provide a dispenser with a dosing device that allows improved dosing and faster work with this dispenser.

The present invention provides a dispenser for cartridges comprising at least one piston rod, an advancing means that can be coupled incrementally to the piston rod in order to move the piston rod in a dispensing direction, and comprising a selectively adjustable control means for the variable pre-selection of the path of travel of the piston rod that, once it has traversed the pre-selected path of travel, uncouples the advancing means from the piston rod. Here, the control means does not serve as a stop that actively limits the path of travel of the piston rod, but rather, merely as an actuation element or as part of an actuation device that, once the pre-selected path of travel has been traversed, causes the advancing means to be uncoupled from the piston rod. This uncoupling of the advancing means offers several advantages: for one thing, once the path of travel has been traversed, through the release of the advancing means and the resultant decrease in the application forces, the user receives direct feedback that the desired path of travel has been traversed and thus that the desired amount of construction material has been applied. This is advantageous particularly with highly viscous construction materials since here, the feedback from a simple stop is often not sufficient. By releasing the advancing means, an elevated application force cannot be transmitted to the piston rod and the control means, so that damage to the dispenser can be prevented. Moreover, there are fewer mechanical stresses on the control means, since the control means does not have to actively limit the path of travel, so that damage to the control means can be ruled out, as a result of which the service life of the dispenser can be greatly increased.

The control means can be affixed onto the piston rod, for example, by means of a locking device, preferably selectively. This means that the path of travel can be set on the piston rod, as is the case with the dosing means used up until now. Thus, values based on experience can be employed and the users do not have to change their routines.

On the advancing means, an actuator is preferably provided towards which the control means can be moved and which brings about the uncoupling of the advancing means when it is actuated by the control means.

The actuator is coupled, for instance, to an unlocking device provided on the advancing means. As soon as the control means has reached the actuator and has actuated it, the advancing means is immediately uncoupled from the piston rod by means of the unlocking device. This ensures that the control means and the unlocking device are not exposed to high mechanical forces and that damage due to an elevated exertion of force is reliably prevented.

In order to ensure fast work with the dispenser, there may be a need for a quick and simple, preferably gradual adjustment or setting of the control means on the piston rod. This can be achieved, for example, in that the locking device of the control means has a clamping element that engages with the piston rod, especially by wedging against the piston rod. Due to this wedging, the locking device can be easily affixed without additional tools or moving parts, for example, screws, which can get dirty. In order to effectuate the clamping, all that is necessary is to tilt the locking device against the piston rod. Likewise, the locking device can be released again simply by tilting it in the opposite direction.

The clamping element can have, for example, a cutout through which the piston rod extends, whereby the clamping element can be tilted in order to be clamped onto the piston rod. In this case, the diameter of the cutout is slightly larger than the diameter of the piston rod, and it is selected in such a way that, when the clamping element is perpendicular to the piston rod, the latter is released, and when the clamping element is tilted against the piston rod, the edge of the cutout comes into contact with the piston rod, as a result of which the clamping element is wedged against the piston rod.

The locking device can be mounted, for example, so as to swivel, in order to activate the control means. Thus, the activation can be effectuated by tilting the entire locking device, whereby the clamping element is clamped on the piston rod. Preferably, the locking device is mounted onto the piston rod or onto the dispenser in such a way that it can be operated directly from the outside.

A lever may be provided on the locking device in order to easily deactivate the locking device. Pressing on the lever eliminates the wedging of the clamping element so that it is tilted to once again be perpendicular to the piston rod. The lever can be joined, for example, rigidly, to the locking device or to the entire control means. In other words, the entire control means is made in one piece, so that it does not have any parts that move with respect to each other.

In order to permit fast working or a fast, repeated dosing of the construction material, a return mechanism can be provided that, after the control means has been deactivated, moves the control means opposite to the dispensing direction towards the piston rod and back into the starting position. This makes it possible to greatly increase the working speed: before the dispensing step, the user affixes the control means onto the piston rod by tilting the locking device. Once the dosing procedure has been completed, the user merely has to unlock the clamping element, which causes the control means return to the starting position once again. Thus, the user only has to select the desired amount of construction material or to set the desired path of travel at the beginning of the work. Subsequently, there is only a need to alternately affix and release the control means. As a result, a readjustment or setting of the path of travel after each dosing procedure is not necessary, so that it is ensured that the same amount of construction material is always dispensed.

The return mechanism can have, for example, a spring that, after the deactivation, pushes the control means back into the starting position. The spring can be tensioned when the piston rod and the control means that is affixed onto the piston rod are moved, so that, after the control means has been released, the spring moves the control means back into the starting position.

The control means can be locked to the piston rod and uncoupled from the piston rod, for instance, manually. However, it is also conceivable for the control means to be automatically unlocked after the piston rod has been uncoupled from the advancing means. In other words, once the pre-selected path of travel has been traversed and once the control means has been uncoupled, if applicable with a time delay, the control means can be unlocked, so that it automatically returns to the starting position by means of the return mechanism. The user merely has to activate the locking device again at the beginning of a new dosing procedure. It is also conceivable for the control means to be automatically locked to the piston rod once again after the starting position has been reached, thereby allowing a much faster work cycle.

Preferably, in order to pre-select the path of travel, a setting element, especially a movable stop, is provided on the control means in order to set the path of travel on the piston rod.

In order to also carry out work for which a pre-selected dosing is not desired or required, it is also conceivable that the control means can be moved into a deactivated position in which it does not engage with the piston rod. Consequently, the dispenser can also be used for the manual dosing of the construction material.

In order to prevent the control means from twisting, preferably two essentially parallel piston rods are provided on which the control means is mounted.

### BRIEF DESCRIPTION OF THE DRAWINGS

Additional features and advantages can be gleaned from the description below in conjunction with the accompanying drawings. These show the following:

FIG. 1 a dispenser according to the invention,

FIG. 2 a partial sectional view of the dispenser of FIG. 1,

FIG. 3 a top view of the dispenser of FIG. 1,

FIG. 4 a detailed view of the control means in the non-activated state,

FIG. 5 a detailed view of the control means in the activated state,

FIG. 6 a detailed view of the dispenser of FIG. 5, and

FIG. 7 a schematic diagram showing a variant of the unlocking device.

### DETAILED DESCRIPTION

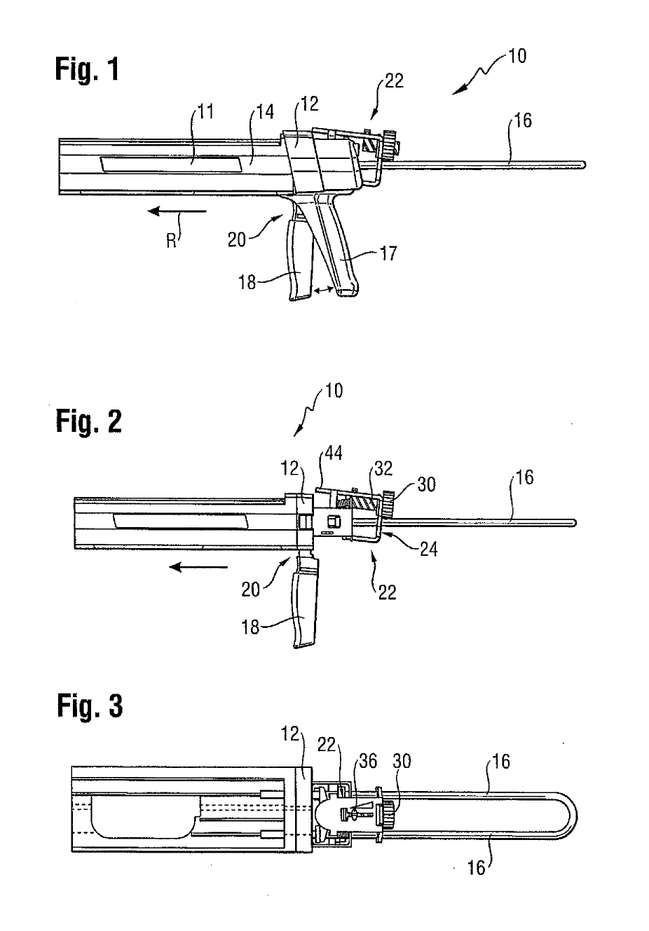

FIG. 1 shows a dispenser 10 for a cartridge 11. Such a cartridge has a cylindrical body that is filled with a easy-flow construction material, for example, silicon. In the case of very fluid construction materials, these are also held, for example, in an additional bag. A dispensing opening is provided for the construction material in one end wall, here the end wall shown on the left in FIG. 1. The opposite end wall is formed by a movable plunger that is mounted in the cylindrical body so that it can move in a dispensing direction R towards the first end wall. By moving the plunger in the advancing direction R, the volume of the body is reduced, so that the construction material can be dispensed from the dispensing opening.

Here, the dispenser 10 has a housing 12, a holder or holding means 14 that can accommodate the cartridge 11, as well as two parallel piston rods 16 that are mounted in the housing 12 so that the piston rods can move in the advancing direction R and so as to interact with the cartridge via a plunger. Moreover, a handle 17 as well as an operating lever 18 for an advancer or advancing means 20 are provided on the housing 12.

When the operating lever 18 is swiveled towards the handle 17, the advancing means 20 is first coupled to the piston rod 16 and, when the operating lever 18 is swiveled further, the advancing means 20 moves the piston rod 16 in the dispensing direction R. After the advancing procedure has been terminated, the operating lever 18 is swiveled away from the handle 17, whereby the advancing means 20 is released from the piston rod 16 and it returns to a basic position in which another advancing procedure can be initiated.

In order to prevent the piston rods 16 from moving opposite to the dispensing direction R, an affixer or affixing means is provided that affixes the piston rods 16 as soon as they have been uncoupled from the advancing means 20. Thus, repeatedly actuating the advancing means 20 allows incremental dispensing from the cartridge 11.

Many applications require a precise dosing of the construction material or of the dispensed amount of construction material. In the case of large amounts, this is done, for example, by counting the number of strokes that are executed by the operating lever 18, or else by means of a stop that is affixed onto the piston rod 16 and that is moved against a counter-stop on the housing. After each dosing procedure, however, the stop has to be realigned, which is very time-consuming. Moreover, in the case of highly viscous construction materials, which call for a great deal of application force, it is difficult for the user to immediately detect that the stop has been reached, so that if the dispensing procedure is not immediately terminated, the high forces exerted can cause deformations of or even damage to the dispenser 10.

In order to prevent this, a controller or control means 22 is provided on the dispenser 10 (also see FIG. 2). This control means 22, as shown below, can uncouple the advancing means 20 from the piston rods 16 once the pre-selected, variable path of travel has been traversed.

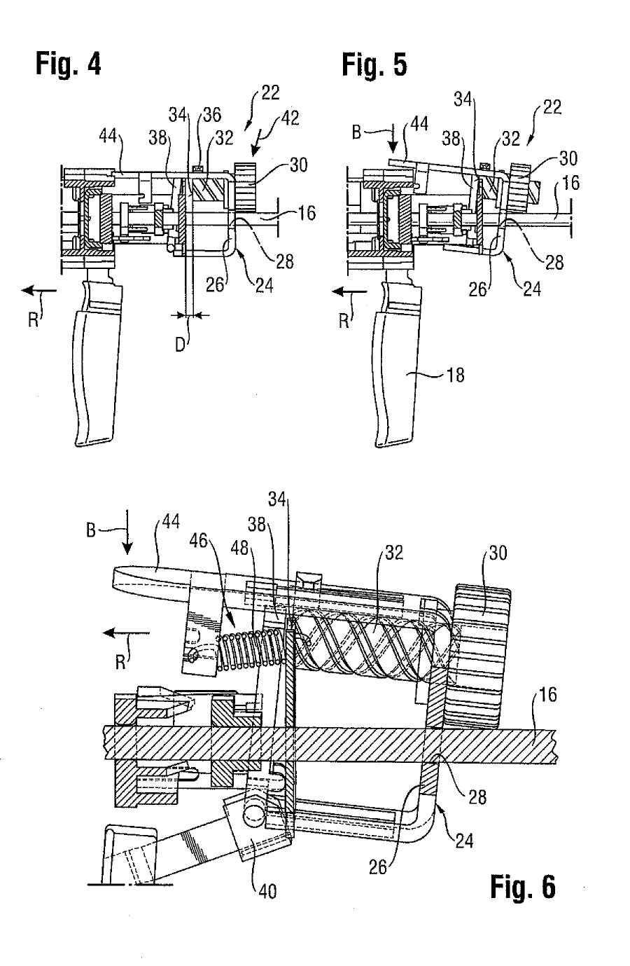

The control means 22, as can be seen in FIGS. 4 to 6, has a stirrup-shaped locking device 24 with which the control means 22 can be affixed onto the piston rod 16. The locking device 24 here has a plate-shaped clamping element 26 having two cutouts 28 through which the piston rods 16 extend. The clamping element 26 is the middle leg of the stirrup, which is mounted so as to swivel.

The diameter of the cutouts 28 is slightly larger than the diameter of the piston rods 16, so that, in the perpendicular position of the clamping element 26 with respect to the piston rods 16, the control means 22 can be moved on the piston rods 16 in the dispensing direction R. By tilting the clamping element 26, the locking device 24 can be affixed onto the piston rods 16, so that the locking device 24 is carried along when the piston rods 16 are moved. This affixing constitutes a wedging of the clamping element against the piston rods at the edge of the cutouts 28.

The control means 22 also has a setting element 30 that has a setting screw 32 as well as a stop 34 that can be moved on the setting screw 32. As is shown especially in FIG. 3, a display element 36 that can be seen from the outside is provided on the stop 34 in order to show the position of the stop 34 or of the pre-selected path of travel on a scale. The stop 34 can be formed by the end wall of the setting screw 32.

On the advancing means 20, there is an actuator 38 (see FIG. 6) towards which the stop 34 of the control means is slid when the piston rod is moved. The actuator 38 is coupled to an unlocking device 40 that—upon activation by the actuator 38—uncouples the advancing means 20 from the piston rods 16.

In a starting position of the control means, as shown, for instance, in FIG. 4, the control means 22 is oriented in such a way that the clamping element 26 is arranged essentially perpendicular to the piston rods 16. The piston rods 16 and the control means 22 are thus not coupled to each other. The setting element 30 is oriented in such a way that the stop 34 is arranged at a distance D from the actuator 38 corresponding to the desired path of travel of the piston rods 16. When the setting screw 32 is turned, the stop 34 can be moved in the advancing direction R and thus the distance D, that is to say, the path of travel, can be adjusted.

In a subsequent step, the clamping element 26 is tilted against the piston rods 16, for example, by exerting pressure onto the control means 22 as indicated by the arrow 42 in FIG. 4, so that the clamping element 26 is wedged against the piston rods 16 and the control means 22 is affixed onto the piston rods 16 (FIG. 5).

When the operating lever 18 is actuated, the advancing means 20 is coupled to the piston rods 16, as a result of which the advancing means 20 is moved along in the dispensing direction R. The control means 22 that is affixed onto the piston rods 16 is moved with the stop 34 towards the actuator 38 until the stop 34 rests against it and the actuator 38 activates the unlocking device 40. The unlocking device 40 uncouples the advancing means 20 from the piston rods 16, so that the piston rods 16 can no longer advance, even if the operating lever 18 is actuated further.

Consequently, it is no longer possible to exert force onto the piston rods 16 via the operating lever 18 or via the advancing means 20. The operating lever 18 can be moved without resistance, as a result of which the user receives unambiguous feedback that the desired path of travel has been traversed. Since the advancing means is not coupled to the piston rods 16, damage to the advancing means 20 or to the piston rods 16 due to excessive application force is ruled out.

In order to deactivate the control means 22 after the dosing procedure, an operating lever 44 is also provided on the control means 22 or on the locking device 24. In the embodiment shown, the operating lever 44 is formed by the upper leg of the stirrup-shaped locking device 24. When pressure is exerted onto the operating lever 44 in the operating direction B, the control means 22 is swiveled counterclockwise relative to FIG. 6, as a result of which the clamping element 26 is likewise swiveled into a position that is perpendicular to the piston rods 16, and the clamping of the clamping element 26 to the piston rods 16 is released. Subsequently, the control means 22 can be moved back into the starting position once again.

For this purpose, in the embodiment shown here, a return mechanism 46 is provided which has a return spring 48 that is arranged between the control means 22 and the housing 12 and that is pre-tensioned when the control means 22 is moved out of its starting position. When the locking device 24 is released, the control means 22 is automatically moved back into the starting position once again, thanks to the pre-tensioned spring 48.

Such a dispenser 10 allows fast and repeated dosing of the construction material. In order to activate the control means 22, there is merely a need to apply pressure as indicated by the arrow 42, as a result of which the locking device 24 is clamped onto the piston rods 16 and carried along when the contents of the cartridge are dispensed, until the stop 34 triggers the actuator 38. After the dosing has been carried out and the advancing means 20 has been uncoupled, there is merely a need to apply pressure onto the lever 44 in order to unlock the control means 22 from the piston rods and to cause the control means 22 to return to the starting position. Subsequently, a new dosing procedure can be initiated by once again locking the control means 22.

Instead of the embodiment shown here, in which the locking device 24 has to be manually unlocked by the lever 44, it is, for example, also conceivable to have an automatic, optionally time-delayed, deactivation of the locking device 24, as soon as the piston rod has been uncoupled from the advancing mechanism.

The user merely has to set the desired amount of construction material or the desired path of travel at the beginning of the work procedure. After a dosing procedure, after the piston rods 16 have been uncoupled from the advancing means 20, and after the operating lever 18 has been released, the control means 22 can automatically return to the starting position, as a result of which a new dosing procedure can immediately be initiated. It is also conceivable for the control means 22 to be automatically coupled to the piston rod 16 again once it has reached the starting position, thus allowing the work to be done even more quickly.

Another improvement can be achieved in that the control means 22 can be moved into a deactivated position in which it does not engage with the piston rod 16. Thus, the dispenser 10 can also be used without a control means 22 or a limitation of the path of travel.

It is, for instance, also conceivable for only one piston rod to be provided instead of two piston rods 16.

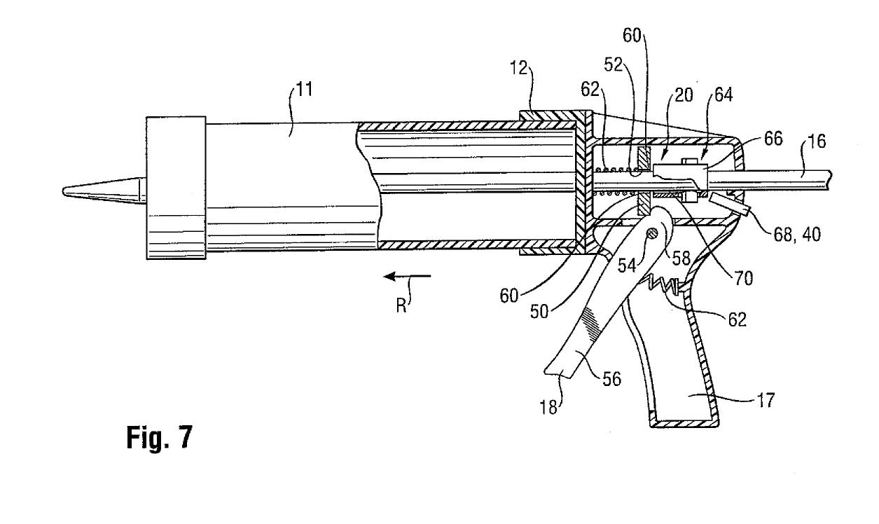

The function of the advancing means 20 as well as the unlocking device 40 are shown in FIG. 7.

The advancing means 20 has a clamping element 50 that is mounted by means of a circular cutout 52 on the piston rod 16, and it also has an operating lever 18 that is mounted so as to swivel around a bearing 54 on the housing 12 and that has an operating arm 56 as well as a clamping arm 58 that can engage with the clamping element 50.

The diameter of the cutout 52 of the clamping element 50 is larger than the diameter of the piston rod 16 so that the clamping element 50 is arranged in a release position in which the clamping element 50 is essentially parallel to a plane that is perpendicular to the longitudinal axis of the piston rod 16. If the clamping element 50 is tilted with respect to this plane, two opposite clamping points 60 of the cutout 52 come into contact with the piston rod 16 and become wedged against it.

If the operating lever 18 is swiveled counterclockwise around the bearing 54, that is to say, if it is moved towards the handle 17, the clamping arm 58 comes into contact with the lower section of the clamping element 50 and forces it in the advancing direction R. As a result, the clamping element 50 is tilted and it becomes wedged against the piston rod 16. If the operating lever 18 is pushed further, the clamping arm 58 forces the clamping element 50 and the piston rod 16, which is wedged against the clamping element 50, in the advancing direction R, as a result of which the contents of the cartridge 11 are dispensed.

If the operating lever 18 is released, it is forced clockwise back into the starting position by a spring element 62, so that the operating lever 18 can be operated once again. Here, the spring element 62 engages with the clamping element 50 and, after being released, moves the clamping element 50 into a position that is perpendicular to the longitudinal axis of the piston, in which position the clamping element 50 is uncoupled from the piston rod 16. Subsequently, the clamping element 50 is moved back into a starting position by this spring element 62, opposite to the advancing direction R.

After the advancing means 20 has been released, in order to affix the piston rod 16 in such a way that it is in contact with the cartridge 11 or with the plunger at the start of a new advancing procedure and in such a way that an empty stroke of the advancing means 20 is prevented, a locking mechanism 64 is provided that is formed here by a second clamping element 66 that is likewise configured with a circular cutout on the piston rod 16.

The second clamping element 66 is spring-loaded and wedged against the piston rod 16 in such a way as to be affixed opposite to the advancing direction R. If the piston rod 16 is moved in the advancing direction R by the advancing means 20, the second clamping element 66 is carried along by the piston rod 16 so as to reduce the angle of inclination relative to a plane that is perpendicular to the longitudinal axis of the piston, as a result of which the wedging of the second clamping element 66 is released.

Once the advancing procedure has ended, the second clamping element 66 springs back to such an extent that it is again wedged against the piston rod 16, thus preventing the piston rod 16 from sliding back opposite to the advancing direction R.

The second clamping element 66 can also be actuated manually in order to take the pressure off the piston rod 16 and thus off the cartridge 11. Here, the second clamping element is coupled via a connecting element 70 to the first clamping element 50 of the advancing means 20, so that, when the second clamping element 66 is released, the first clamping element 50 is also released from the piston rod 16 and the pressure on the piston rod 16 can be relieved.

The unlocking device 40 has a coupling rod 68 that engages with the second clamping element 66 and that can release the wedging of the second clamping element 66 against the piston rod 16. When the second clamping element 66 is released, the connecting element 70 also releases the first clamping element 50 from the piston rod, so that the flow of force between the operating lever 18 and the piston rod 16 is interrupted. However, the unlocking means 40 can also engage directly with the first clamping element 50 via the coupling rod 68, so that the advancing means 20 is separated from the piston rod, but the piston rod 16 continues to be affixed by the second clamping element 66, so that an empty stroke of the piston rod 16 is prevented during the subsequent dispensing procedure.

What is claimed is:

1. A dispenser for cartridges, the dispenser comprising:
at least one piston rod;
an advancer coupleable incrementally to the piston rod to move the piston rod in a dispensing direction; and
a selectively adjustable controller for variable pre-selection of a path of travel of the piston rod, the controller, once the piston rod has traversed the pre-selected path of travel, uncoupling the advancer from the piston rod.

2. The dispenser as recited in claim 1 wherein the controller is affixable onto the piston rod via a lock, and further comprising an actuator on the advancer, the controller movable towards the actuator.

3. The dispenser as recited in claim 2 wherein the controller is selectively affixable to the piston via the lock.

4. The dispenser as recited in claim 2 further comprising an unlocker for the piston rod coupled to the actuator.

5. The dispenser as recited in claim 2 wherein the lock has a clamp engaging with the piston rod.

6. The dispenser as recited in claim 5 wherein the clamp forms a wedge against the piston rod.

7. The dispenser as recited in claim 5 wherein the clamp has a cutout, the piston rod extending through the cutout, the clamp tiltable in order to be clamped onto the piston rod.

8. The dispenser as recited in claim 2 wherein the lock is mounted so as to swivel to activate the controller.

9. The dispenser as recited in claim further comprising a lever on the lock to deactivate the lock.

10. The dispenser as recited in claim 2 further comprising a return, the return, after the controller has been deactivated, moving the piston rod opposite to the dispensing direction and back into the starting position.

11. The dispenser as recited in claim 10 wherein the return has a spring engaging with the controller.

12. The dispenser as recited in claim 2 wherein the controller is automatically unlocked after the piston rod has been uncoupled from the advancer.

13. The dispenser as recited in claim 1 further comprising a setter on the controller to set the path of travel of the piston rod.

14. The dispenser as recited in claim 13 wherein the steer includes a movable stop.

15. The dispenser as recited in claim 1 wherein the controller is movable into a deactivated position disengaged from the piston rod.

16. The dispenser as recited in claim 1 wherein the at least one piston rod includes two parallel piston rods, the controller mounted on the two parallel piston rods.
